(19) United States
(12) Patent Application Publication
(10) Pub. No.: US 2017/0032565 A1
(43) Pub. Date: Feb. 2, 2017

(54) THREE-DIMENSIONAL FACIAL RECONSTRUCTION METHOD AND SYSTEM

(71) Applicant: SHENZHEN UNIVERSITY, Shenzhen (CN)

(72) Inventors: Xiang PENG, Shenzhen (CN); Xiaoli LIU, Shenzhen (CN); Dong HE, Shenzhen (CN); Hailong CHEN, Shenzhen (CN); Chen XU, Shenzhen (CN)

(21) Appl. No.: 15/114,649

(22) PCT Filed: Jul. 13, 2015
(86) PCT No.: PCT/CN2015/083889

§ 371 Date: Jul. 27, 2016

(51) Int. Cl. G06T 15/20; G06T 7/00

(52) U.S. Cl. CPC G06T 15/205; G06T 7/002; G06T 2207/10028; G06T 2207/10012; G06T 2200/08; G06T 15/005

(57) ABSTRACT

The present invention is applicable to the field of image processing technology, provides a three-dimensional facial reconstruction method and system comprising: arranging three-dimensional imaging units with the same configuration on both of left side and right side of a target human face; implementing binocular calibration to the three-dimensional imaging units; establishing a polynomial relation between 3D point cloud coordinates captured by the three-dimensional imaging units and corresponding phases according to a result of the binocular calibration and determining the transformation relation among the 3D point cloud coordinates captured by two three-dimensional imaging units; capturing image sequences on the left side and right side of the target human face by the three-dimensional imaging units to obtain absolute phases of the image sequences; mapping the absolute phases of the image sequences to the 3D point cloud coordinates by using the polynomial relationship; unifying the 3D point cloud coordinates of the three-dimensional imaging units to a global coordinate system according to the transformation relationship. The present invention implements a rapid three-dimensional reconstruction of a face and improves the processing efficiency of three-dimensional facial reconstruction.

### TECHNICAL FIELD

The present invention belongs to the field of computer graphics technology, particularly to a three-dimensional facial reconstruction method and system.

### BACKGROUND

With the development of computer graphics technology, three-dimensional (3D) face modeling has become a hot research field of computer graphics. The 3D face modeling is gradually applied to the fields of virtual reality, film and television production, medical plastic surgery, face recognition, video games and many other fields, and has a strong practical value.

In the three-dimensional face modeling process, the optical imaging technology is widely used by the technical staff due to its non-invasive, fast data capture, high measurement precision, where the three-dimensional imaging technology based on the fringe projection technology has received basic mature application, however, the method has low data measurement speed, resulting in that a three-dimensional face modeling efficiency is affected.

### SUMMARY

Embodiments of the present invention provide a three-dimensional facial reconstruction method and apparatus, aims at solving the problem that the three-dimensional imaging technology based on the fringe projection technology has low data measurement speed, resulting in that a three-dimensional face modeling efficiency is affected.

The embodiment of the present invention is implemented by a three-dimensional facial reconstruction method comprising:

arranging three-dimensional imaging units with the same configuration on left side and right side of a target human face;

implementing binocular calibration to the three-dimensional imaging units, according to a result of the binocular calibration establishing a polynomial relation between 3D point cloud coordinates captured by the three-dimensional imaging units and corresponding phases and determining the transformation relation among the 3D point cloud coordinates captured by two three-dimensional imaging units;

capturing image sequences on the left side and right side of the target human face by the three-dimensional imaging units to obtain absolute phases of the image sequences;

mapping the absolute phases of the image sequences to the 3D point cloud coordinates by using the polynomial relationship;

unifying the 3D point cloud coordinates of the three-dimensional imaging units to a global coordinate system according to the transformation relationship, to complete the three-dimensional reconstruction of the target human face.

Another object of an embodiment of the present invention is to provide a three-dimensional facial reconstruction system comprising:

an arrangement unit, configured to arranging three-dimensional imaging units with the same configuration on left side and right side of a target human face;

a calibration unit, configured to implement binocular calibration to the three-dimensional imaging units, establish a polynomial relation between 3D point cloud coordinates captured by the three-dimensional imaging units and corresponding phases according to a result of the binocular calibration and determine the transformation relation among the 3D point cloud coordinates captured by two three-dimensional imaging units;

a capture unit, configured to capture image sequences on the left side and right side of the target human face by the three-dimensional imaging units to obtain absolute phases of the image sequences;

a mapping unit, configured to map the absolute phases of the image sequences to the 3D point cloud coordinates by using the polynomial relationship;

a reconstruction unit, configured to unify the 3D point cloud coordinates of the three-dimensional imaging units to a global coordinate system according to the transformation relationship, to complete the three-dimensional reconstruction of the target human face.

In the embodiment of the invention, during the three-dimensional facial reconstruction, the process of finding the corresponding point according to conjugate lines and phase values may be avoided , to complete fast three-dimensional reconstruction for the face, while by calibrating the transformation relation between the left and the right three-dimensional imaging units, it may complete automatic matching of the three-dimensional data of the left side and the right side, and improve the processing efficiency of three-dimensional facial reconstruction.

### BRIEF DESCRIPTION OF THE DRAWINGS

In order to illustrate technical solutions of the embodiments of the present invention more clearly, the drawings which is required when the embodiments and the prior art are described is briefly described.

Apparently, the drawings described below are merely some embodiments of the present invention, those ordinary skilled persons may obtain other drawings based on these drawings without paying creative works.

FIG. 1 is a flow chart a three-dimensional facial reconstruction method according to an embodiment of the present invention;

FIG. 2 is a schematic setting of a three-dimensional imaging unit according to an embodiment of the present invention;

FIG. 3 is a specific flow chart of S102 of the three-dimensional facial reconstruction method according to an embodiment of the present invention;

FIG. 4 is a schematic principle diagram of S102 of the three-dimensional facial reconstruction method according to an embodiment of the present invention;

FIG. 5 is a process flow diagram of a three-dimensional face reconstruction method according to an embodiment of the present invention;

FIG. 6 is a block diagram of a three-dimensional face reconstruction system according to an embodiment of the present invention.

### DETAILED DESCRIPTION OF THE EMBODIMENT

The following description intends to illustration but not to limitation, and presents details such as specific structure, technology or the like, such that embodiments of the present invention may be understood completely. However, those skilled in the art should understand that other embodiments without these details can also implement the present invention. In other instances, detailed explanations for well-known systems, devices, circuits, and methods are omitted, so as not to prevent the unnecessary details from interfering with description of the invention.

To illustrate the technical solutions of the present invention, the following specific embodiments will be described.

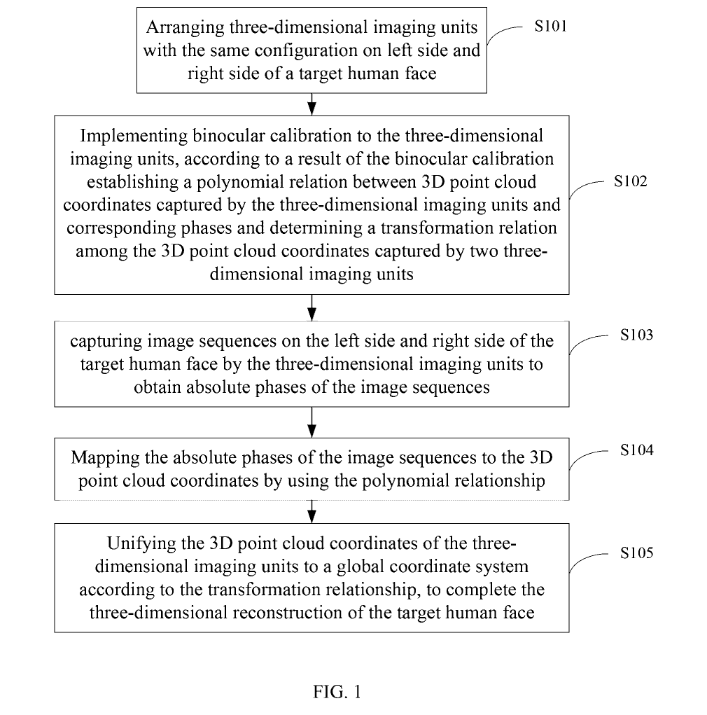

FIG. 1 illustrates a flow chart of a three-dimensional facial reconstruction method according to an embodiment of the present invention, the follow chart is as follow:

In S101, three-dimensional imaging units with the same configuration are arranged on left side and right side of a target human face.

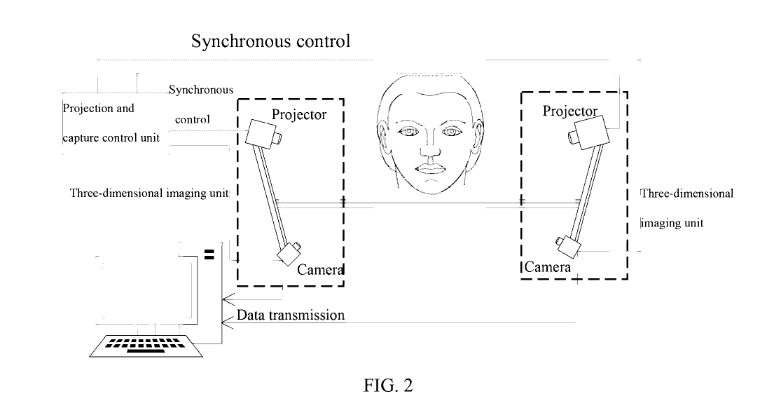

In this embodiment, shown in FIG. 2, the left side and right side of the target human face are provided with three-dimensional imaging units with the same configuration configured to respectively obtain 3D point cloud data on the right side and left side of the target human face. Specifically, each of the three-dimensional imaging units comprises a projector and an industrial camera, and the camera serves as a reverse projector. The camera is connected to a computer via a GigE port, to send the captured image to the computer to be processed. Illustratively, in each of the three-dimensional imaging unit, the angle between the projector and the optical axis of the camera is about 30 degrees. In the embodiment of the invention, in order to complete synchronous capture of image sequences, a projection and capture control unit shown in FIG. 2 is provided, to synchronously control an image projection operation of the projector and an image capture operation of the camera.

In S102, the three-dimensional imaging units are implemented a binocular calibration, according to a result of the binocular calibration a polynomial relation between 3D point cloud coordinates captured by the three-dimensional imaging units and corresponding phases is established and a transformation relation among the 3D point cloud coordinates captured by two three-dimensional imaging units is determined.

Because the three-dimensional imaging units arranged on the left side and left side have the same configuration, two different three-dimensional imaging units at different position have the same calibration way during the binocular calibration, and the transformation relation among the 3D point cloud coordinates captured by the two three-dimensional imaging units may be determined according to the result of the binocular calibration.

In S102, plane targets each with a surface printed with a given datum of three-dimensional coordinates are placed in different orientations, the two three-dimensional imaging units are controlled to sequentially illuminate the targets uniformly and project phase shifts and Gray code structured light, and the cameras are controlled to capture a uniform illumination and deformation structure images under each orientation, on this basis, the polynomial relation between 3D point cloud coordinates and the phases is fitted for each three-dimensional imaging unit.

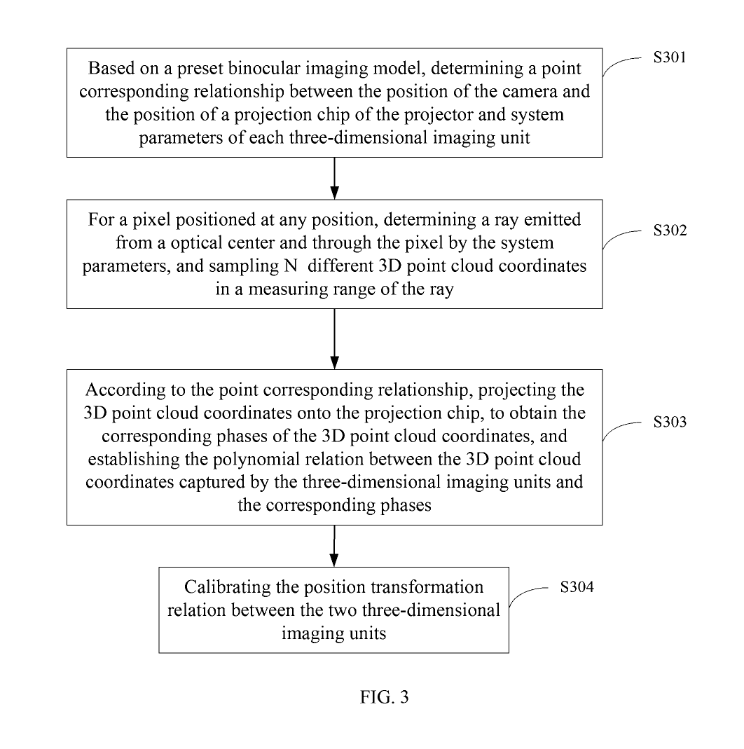

Specifically, as shown in FIG. 3:

In S301, based on a preset binocular imaging model, a point corresponding relationship between the position of the camera and the position of a projection chip of the projector and system parameters of each three-dimensional imaging unit are determined.

According to the binocular calibration method described in the literature “Phase-Unwrapping Based on Complementary Structured Light Binary Code, SUN, Xuezhen, ZOU, Xiaoping, ACTA OPTICA SINICA, No. 10,Vol. 28”, the projector of each of the three-dimensional imaging units shown in FIG. 2 served as a reverse camera, the binocular imaging model is as follow:

$$\{ \begin{matrix}{X}_{c} = {R}_{c} {X}_{w} + {t}_{c} \\ {s}_{c} {\tilde{m}}_{c} = {K}_{c} {\tilde{X}}_{c} \\ {m}_{c} = {\hat{m}}_{c} - δ ( {m}_{c} ; {θ}_{c} ) \\ {s}_{p} {\tilde{m}}_{p} = {K}_{p} [ {R}_{s} \vert {T}_{s} ] {\tilde{X}}_{c} \\ {m}_{p} = {\hat{m}}_{p} - δ ( {m}_{p} ; {θ}_{p} )\end{matrix} ,$$

Such binocular imaging model determines the point corresponding relationship of the camera position and the projector chip position. Based on the binocular imaging model, the system parameters (R_{cl}, t_{cl}, K_{cl}, δ_{cl}, Rₛₗ, tₛₗ, Kₚₗ, δₚₗ) and (R_{cr}, t_{cr}, K_{cr}, δ_{cr}, Rₛᵣ, tₛᵣ, Kₚᵣ, δₚᵣ) of the two three-dimensional imaging units on the left and right can be respectively obtained.

In S302, for a pixel of camera at any pixel location, a ray emitted from a optical center and through such pixel may be determined through the system parameters, N different 3D point cloud coordinates are sampled in a measuring range of the ray, N is a integer larger than 1.

In S303, according to the point corresponding relationship, the 3D point cloud coordinates are projected onto the projection chip, to obtain the corresponding phases of the 3D point cloud coordinates; and the polynomial relation between the 3D point cloud coordinates captured by the three-dimensional imaging units and the corresponding phases are established.

Firstly, for the projection chip, its phases distribution is obtained over generated ideal fringes and has no relation to three-dimensional scene and presents a linear distribution along the 3D point cloud coordinates, therefore, for the three-dimensional imaging unit having implemented the binocular calibration, a continuous function of closed interval may be used to express the corresponding relationship between the phase of each pixel and the 3D point cloud coordinate of such pixel. According to Weierstrass approximation theorem, any continuous function of closed interval can be approximately expressed by a polynomial, therefore, the polynomial of phase is used to approximately express the 3D point cloud coordinate corresponding to one pixel:

x_{w}=fₓ(φ_{c})=a₀+a₁φ_{c}+a₂φ_{c}² . . . +aₙφ_{c}ⁿ

y_{w}=f_{y}(φ_{c})=b₀+b₁φ_{c}+b₂φ_{c}² . . . +bₙφ_{c}ⁿ

z_{w}=f_{z}(φ_{c})=c₀+c₁φ_{c}+c₂φ_{c}² . . . +cₙφ_{c}ⁿ

The polynomial coefficients [symbol] represent nth order polynomial mapping relations between phase [symbol] and the 3D point cloud coordinate

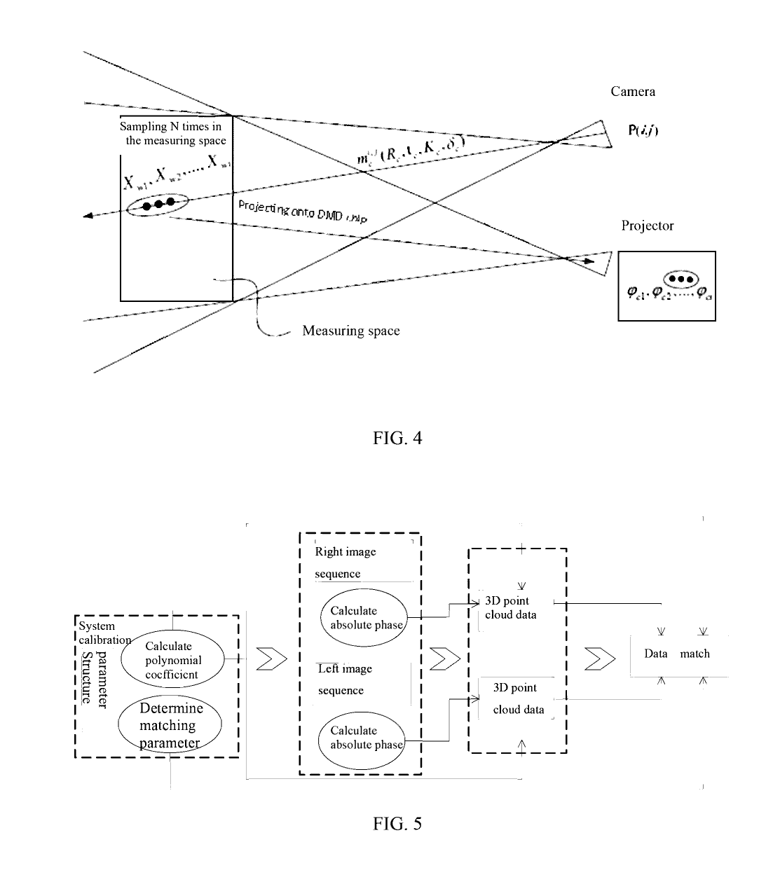

Secondly, for the camera, as shown in FIG. 4, for a pixel of camera at any pixel location [symbol] , a ray emitted from a optical center and through such pixel determined through the system parameters is [symbol] , N different 3D point cloud coordinates [symbol] are sampled in a measuring range of the ray,. In order to get absolute values corresponding to these points, according to the binocular imaging model in S301, the positions [symbol] of the sampled points in the projection chip (DMD chip) are determined, the 3D point cloud coordinates are projected onto the projection chip, and according to the linear relation between the absolute phases and the projection chip position ( [symbol] is the spatial period of phase shifted fringes), the corresponding phase [symbol] may be obtained, whereby the corresponding relation between the phase and the 3D coordinate is obtained according to the Weierstrass approximation theorem:

x_{wi}=a₀+a₁φ_{ck}+a₂φ_{ck}² . . . +aₙφ_{ck}ⁿ

y_{wi}=b₀+b₁φ_{ck}+b₂φ_{ck}² . . . +bₙφ_{ck}ⁿ

z_{wi}=c₀+c₁φ_{ck}+c₂φ_{ck}² . . . +cₙφ_{c}ⁿ k=1,2, . . . N

When the number of sampled points N is greater than the order n of the polynomial, the least squares solution of over-determined equation is used to determine the polynomial coefficients [symbol] thereby determining the polynomial relation between the 3D point cloud coordinate and the phase.

In S304, the position transformation relation between the two three-dimensional imaging units is calibrated:

[symbol]

where and are respectively a rotation matrix and a translation matrix of the three-dimensional imaging unit on the left and a world coordinate system, and are respectively the rotation matrix and translation matrix of the three-dimensional imaging unit on the right and the world coordinate system, and are respectively used to represent the transformation relationship between two three-dimensional imaging units, and used for automatically matching 3D point cloud data between the two three-dimensional imaging units.

In S103, image sequences on the left side and right side of the target human face are captured by the three-dimensional imaging unit, to obtain absolute phases of the image sequences.

In this embodiment, the two three-dimensional imaging units are controlled to sequentially project phase shifts and Gray code structured light to the target human face, and the cameras are controlled to capture deformation image sequences, to obtain absolute phases of the image sequences.

To obtain absolute phases, firstly a four-step phase-shifting technology is used to obtain folded phase φ(i, j), then unwrapped phase may be obtained according to the coding principle of complementary Gray code, wherein:

$$φ ( i , j ) = arctan \frac{{I}_{4} ( i , j ) - {I}_{2} ( i , j )}{{I}_{1} ( i , j ) - {I}_{3} ( i , j )} ;$$

$$ϕ ( i , j ) = \{ \begin{matrix}φ ( i , j ) + 2 π + 2 π {k}_{1} , & φ ( i , j ) \leq - \frac{π}{2} \\ φ ( i , j ) + 2 π {k}_{2} , & \frac{π}{2} < φ ( i , j ) \leq \frac{π}{2} \\ φ ( i , j ) + 2 π {k}_{1} , & φ ( i , j ) > \frac{π}{2}\end{matrix} ,$$

Wherein k₁ and k₂ are two different folding stages having complementary nature obtained by complementary Gray code.

In S104, the absolute phases of the image sequences are mapped to the 3D point cloud coordinates by using the polynomial relationship.

According to the polynomial relationship between the calibrated phase and the 3D point cloud coordinate, the 3D point cloud coordinate X_{w}(y_{w}, y_{w}, z_{w}) corresponding to the pixel may be obtained.

In S105, the 3D point cloud coordinates of the three-dimensional imaging units are unified to a global coordinate system according to the transformation relationship, to complete the three-dimensional reconstruction of the target human face.

The 3D point clouds Xᵢ, Xᵣ on the left side and the right side are matches to the global coordinate system, the global coordinates may use the three-dimensional imaging unit on the left side as a reference. Referring to the follow:

$$\{ \begin{matrix}{X}_{gr} = {R}_{lr} {X}_{r} + {T}_{lr} \\ {X}_{gl} = {X}_{l}\end{matrix}$$

Thus, the uniformity of X_{gr}, X_{gi} coordinate systems of the three-dimensional imaging units on the left and right side is completed, the three-dimensional reconstruction for the target human face is completed.

In addition, as an embodiment of the present invention, since the three-dimensional facial reconstruction process is independent for each pixel on the imaging plane of the camera, based on the captured image sequences and the calibrated polynomial relation, for each pixel position the 3D point cloud coordinate of the point may be obtained, which has excellent parallelism, therefore, a graphics processing unit (GPU) may be used to accelerate computing to obtain the 3D point cloud data of the entire plane array of the camera in parallel.

The flow chart of the process of the three-dimensional reconstruction is shown in FIG. 5.

In the embodiment of the invention, during the three-dimensional facial reconstruction, the process of finding the corresponding point according to conjugate lines and phase values may be avoided, to complete fast three-dimensional reconstruction for the face, while by calibrating the transformation relation between the left and the right three-dimensional imaging units it may complete automatic matching of the three-dimensional data of the left side and the right side, and improve the processing efficiency of three-dimensional facial reconstruction.

It should be understood that in the above-mentioned embodiments, the sequence numbers of the steps does not mean the executed orders of the steps, the executed order of each process should be determined by feature and inherent logic thereof, and should not limited the implementation process of the embodiment of the present invention.

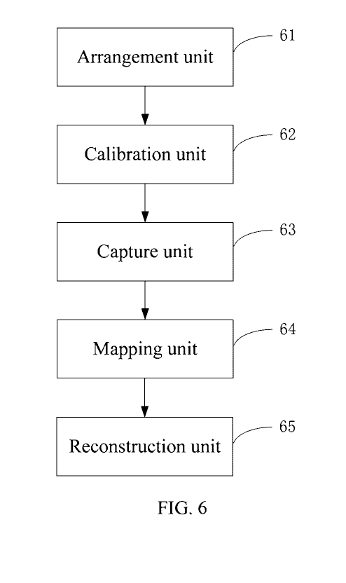

Corresponding to the three-dimensional facial reconstruction method described in the above embodiments, FIG. 6 shows a block diagram of a three-dimensional face reconstruction system according to an embodiment of the present invention, the three-dimensional facial reconstruction system may comprises software units, hardware units or the combination of hardware units and software combination units. For illustration purposes, only the portion related to the embodiment of the present invention is shown.

Referring to FIG. 6, the system comprising:

an arrangement unit 61, configured to arranging three-dimensional imaging units with the same configuration on left side and right side of a target human face;

a calibration unit 62, configured to implement binocular calibration to the three-dimensional imaging units, establish a polynomial relation between 3D point cloud coordinates captured by the three-dimensional imaging units and corresponding phases according to a result of the binocular calibration and determine the transformation relation among the 3D point cloud coordinates captured by two three-dimensional imaging units;

a capture unit 63, configured to capture image sequences on the left side and right side of the target human face by the three-dimensional imaging units to obtain absolute phases of the image sequences;

a mapping unit 64, configured to map the absolute phases of the image sequences to the 3D point cloud coordinates by using the polynomial relationship;

a reconstruction unit 65, configured to unify the 3D point cloud coordinates of the three-dimensional imaging units to a global coordinate system according to the transformation relationship, to complete the three-dimensional reconstruction of the target human face.

Optionally, the arrangement unit 61 comprises:

an arrangement subunit, configured to configure a projector and a camera for each of the three-dimensional imaging unit, and using the projector as a reverse camera;

a setting subunit, configured to provide a projection and capture control unit for controlling an image projection operation of the projector and an image capture operation of the camera.

Optionally, the calibration unit 62 comprises:

a determination subunit, configured to based on a preset binocular imaging model, determining a point corresponding relationship between the position of the camera position and the position of a projection chip of the projector and system parameters of each three-dimensional imaging unit;

a sampling subunit, configured to: for a pixel positioned at any position, determine a ray emitted from a optical center and through the pixel by the system parameters, and sample N different 3D point cloud coordinates in a measuring range of the ray;

an establishing subunit, configured to according to the point corresponding relationship, project the 3D point cloud coordinates onto the projection chip, to obtain the corresponding phases of the 3D point cloud coordinates; and establish the polynomial relation between the 3D point cloud coordinates captured by the three-dimensional imaging units and the corresponding phases.

Optionally, the calibration unit 62 is further configured to:

determine the transformation relation as:

[symbol]

where and are respectively a rotation matrix and a translation matrix of the three-dimensional imaging unit on the left and a world coordinate system, and are respectively the rotation matrix and translation matrix of the three-dimensional imaging unit on the right and the world coordinate system, and are respectively used to represent the transformation relationship two three-dimensional imaging units.

Optionally, the system further comprises:

a parallel computing unit, configured to accelerate computing for parallel processing of each pixel in the image sequences by using a graphics processing unit (GPU).

It may be clearly understood by a person skilled in the art that, for the purpose of convenient and brief description, only the division of the foregoing functional modules is taken as an example for illustration. In actual application, the foregoing functions can be allocated to and implemented by different functional modules and united according to a requirement, that is, an inner structure of an apparatus is divided into different functional modules to implement all or some of the functions described above. Each functional unit or module may be integrated in a single processing unit or may be physically separate, or two or more units are integrated into one unit. The integrated unit may be implemented in a form of hardware, or may be implemented in a form of a software functional unit. For a detailed working process of the foregoing system, apparatus, and unit, reference may be made to a corresponding process in the foregoing method embodiments, and details are not described herein again.

An ordinary person skilled in the art may be aware that, with reference to the examples described in the embodiments disclosed in this specification, units and algorithm steps may be implemented by electronic hardware or a combination of computer software and electronic hardware. Whether these functions are executed in a hardware manner or a software manner depends upon particular applications and design constraint conditions of the technical solutions. A person skilled in the art may use a different method to implement the described functions for each particular application, but it should not be considered that such implementation goes beyond the scope of the present invention.

In the several embodiments provided in the present invention, it should be understood that the disclosed system, apparatus, and method may be implemented in other manners. For example, the described apparatus embodiment is merely exemplary. For example, the module or unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present invention may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the embodiments of the present invention essentially or the portion contributed to the prior art or all or some of the technical solutions may be implemented in the form of a software product. The computer software product is stored in a storage medium and includes several instructions for instructing a computer device (which may be a personal computer, a server, or a network device) or a processor to perform all or some of the steps of the methods in the embodiments of the present invention. The foregoing storage medium includes: any medium that can store program code, such as a USB flash drive, a removable hard disk, a read-only memory (ROM), a random access memory (RAM), a magnetic disk, or an optical disc.

The foregoing embodiments are merely intended for describing the technical solutions of the present invention, but not for limiting the present invention. Although the present invention is described in detail with reference to the foregoing embodiments, ordinary persons skilled in the art should understand that they may still make modifications to the technical solutions described in the foregoing embodiments or make equivalent replacements to some technical features thereof, without departing from the spirit and scope of the technical solutions of the embodiments of the present invention.

The foregoing descriptions are merely exemplary embodiment of the present invention, hut are not intended to limit the present invention. Any modification, equivalent replacement, or improvement made without departing from the spirit and principle of the present invention shall fall within the protection scope of the present invention.

What is claimed is:

1. A three-dimensional facial reconstruction method comprising:
arranging three-dimensional imaging units with the same configuration on left side and right side of a target human face;
implementing binocular calibration to the three-dimensional imaging units, according to a result of the binocular calibration establishing a polynomial relation between 3D point cloud coordinates captured by the three-dimensional imaging units and corresponding phases and determining a transformation relation among the 3D point cloud coordinates captured by two three-dimensional imaging units;
capturing image sequences on the left side and right side of the target human face by the three-dimensional imaging units to obtain absolute phases of the image sequences;
mapping the absolute phases of the image sequences to the 3D point cloud coordinates by using the polynomial relationship;
unifying the 3D point cloud coordinates of the three-dimensional imaging units to a global coordinate system according to the transformation relationship, to complete the three-dimensional reconstruction of the target human face.

2. The method of claim 1, wherein the step of arranging three-dimensional imaging units with the same configuration on left side and right side of a target human face comprises:
configuring a projector and a camera for each of the three-dimensional imaging unit, and using the projector as a reverse camera;
providing a projection and capture control unit for controlling an image projection operation of the projector and an image capture operation of the camera.

3. The method of claim 2, wherein the step of implementing binocular calibration to the three-dimensional imaging units, establishing a polynomial relation between 3D point cloud coordinates captured by the three-dimensional imaging units and corresponding phases according to a result of the binocular calibration and determining the transformation relation among the 3D point cloud coordinates captured by two three-dimensional imaging units comprises:
based on a preset binocular imaging model, determining a point corresponding relationship between the position of the camera and the position of a projection chip of the projector and system parameters of each three-dimensional imaging unit;
for a pixel positioned at any position, determining a ray emitted :from a optical center and through the pixel by the system parameters, and sampling N different 3D point cloud coordinates in a measuring range of the ray;
according to the point corresponding relationship, projecting the 3D point cloud coordinates onto the projection chip, to obtain the corresponding phases of the 3D point cloud coordinates; and establishing the polynomial relation between the 3D point cloud coordinates captured by the three-dimensional imaging units and the corresponding phases.

4. The method of claim 1, wherein the step of determining the transformation relation among the 3D point cloud coordinates captured by two three-dimensional imaging units comprises:
determining the transformation relation as: [symbol]
where and are respectively a rotation matrix and a translation matrix of the three-dimensional imaging unit on the left and a world coordinate system, and are respectively the rotation matrix and translation matrix of the three-dimensional imaging unit on the right and the world coordinate system, and are respectively used to represent the transformation relationship between two three-dimensional imaging units.

5. The method of claim 1, wherein the method further comprises:
accelerating computing for parallel processing of each pixel in the mage sequences by using a graphics processing unit (GPU).

6. A three-dimensional facial reconstruction system comprising:
an arrangement unit, configured to arranging three-dimensional imaging units with the same configuration on left side and right side of a target human face;
a calibration unit, configured to implement binocular calibration to the three-dimensional imaging units, establish a polynomial relation between 3D point cloud coordinates captured by the three-dimensional imaging units and corresponding phases according to a result of the binocular calibration and determine the transformation relation among the 3D point cloud coordinates captured by two three-dimensional imaging units;
a capture unit, configured to capture image sequences on the left side and right side of the target human face by the three-dimensional imaging units to obtain absolute phases of the image sequences;
a mapping unit, configured to map the absolute phases of the image sequences to the 3D point cloud coordinates by using the polynomial relationship;
a reconstruction unit, configured to unify the 3D point cloud coordinates of the three-dimensional imaging units to a global coordinate system according to the transformation relationship, to complete the three-dimensional reconstruction of the target human face.

7. The system of claim 6, wherein the arrangement unit comprises:
an arrangement subunit, configured to configure a projector and a camera for each of the three-dimensional imaging unit, and using the projector as a reverse camera;
a setting subunit, configured to provide a projection and capture control unit for controlling an image projection operation of the projector and an image capture operation of the camera.

8. The system of claim 7, wherein the calibration unit comprises:
a determination subunit, configured to based on a preset binocular imaging model, determining a point corresponding relationship between the position of the camera and the position of a projection chip of the projector and system parameters of each three-dimensional imaging unit;
a sampling subunit, configured to: for a pixel positioned at any position, determine a ray emitted from a optical center and through the pixel, and sample N different 3D point cloud coordinates in a measuring range of the ray;
an establishing subunit, configured to according to the point corresponding relationship, project the 3D point cloud coordinates onto the projection chip, to obtain the corresponding phases of the 3D point cloud coordinates; and establish the polynomial relation between the 3D point cloud coordinates captured by the three-dimensional imaging units and the corresponding phases.

9. The system of claim 6, wherein the calibration unit further configured to:
determine the transformation relation as: [symbol]
where and are respectively a rotation matrix and a translation matrix of the three-dimensional imaging unit on the left and a world coordinate system, and are respectively the rotation matrix and translation matrix of the three-dimensional imaging unit on the right and the world coordinate system, and are respectively used to represent the transformation relationship two three-dimensional imaging units.

10. The system of claim 6, wherein the system further comprises:
a parallel computing unit, configured to accelerate computing for parallel processing of each pixel in the image sequences by using a graphics processing unit (GPU).
